(19) United States
(12) Patent Application Publication
(10) Pub. No.: US 2012/0271658 A1
(43) Pub. Date: Oct. 25, 2012

(54) METHOD FOR A CLOUD-BASED INTEGRATED RISK PLACEMENT PLATFORM

(76) Inventor: Hugh J. Sloan, III, San Ramon, CA (US)

(21) Appl. No.: 13/092,867

(22) Filed: Apr. 22, 2011

(51) Int. Cl. G06Q 40/08

(52) U.S. Cl. 705/4

(57) ABSTRACT

A cloud-based analysis and trading system that can enable virtual management of both placement and pricing of risk between a reinsurer and cedant, or between any other parties. The system can also manage existing contracts and policies. Cloud software can offer risk optimization, entity rating, trading exchanges, billing and payments services, automated recovery, and statutory filing interfaces. Virtual private clouds can be provisioned around specified criteria, such as lines of business, major rating classes, and groups of claims.

### BACKGROUND

1. Field of the Invention

The present invention relates to the field of providing electronic information over a computer network, specifically a method and system for providing a multi-functional risk platform and virtual trading exchange utilizing cloud computing, and in some embodiments a method for placing risk in a virtual private risk network and virtual private exchange.

2. Background

Historically insurance and reinsurance contracts have been conducted via the use of brokers in a situation whereby the free-flow of information between the parties is restricted, obfuscated and/or hidden from the other party or parties by the transacting broker. Moreover, the commissions and/or fees earned by these brokers have been well-guarded secrets, unknown to all but a select few individuals and companies.

Additionally, information regarding various rates across various insurance types, classes, industries and risk groups is generally not available to parties outside the transaction. Thus, while individuals/companies are able to conduct their own internal estimations of risks, premiums and potential exposure, the parties generally work in a vacuum without information from third party sources. Due to this secretive approach to transactions in the insurance and reinsurance markets, primary insurance agencies encounter significant difficulty in calculating actual risks, exposure and ultimately premiums. As a result, premiums on policies tend to be inflated to account for the uncertainty that the agents face in acquiring insurance and reinsurance and/or managing their own risk/exposure.

Furthermore, due to the barriers to communication and webs of secrecy that are created by the various reinsurance brokers, re-insurance transactions can often be long, drawn-out processes that can take months to complete. In the mean time, primary agents and/or cedants can face significant exposure if existing policies are allowed to lapse. Therefore, primary agents and cedants often times will stay with an existing reinsurer while simultaneously attempting to negotiate new rates—all the time potentially paying excess premiums and accruing unnecessary broker fees to the broker “negotiating” the new re-insurance contract.

Moreover, the current systems to not allow truly implement any systems for screening and culling or differentiating various groups with customized needs. Presently, creation of pools of parties (be it cedants, reinsurers, brokers or any other grouping) is for the most part limited to buying pools where groups with similar insurance needs haphazardly find each other and use collective bargaining power, rather ineffectively, to reduce insurance costs.

Still further, due to this synchronized blind type transaction that takes place in the reinsurance market, the cedant and broker have very poor visibility during the transaction and during the policy in-force period, it is very difficult to gauge the overall health of the cover, cedant and the reinsurer. That is, at any given time during the term of the cover, the cedant and/or reinsurer do not have a clear picture of risk, exposure, pricing and/or profitability.

Given the long lag times between the engagement of a broker and the execution of alternate cover, it is all but impossible under the current system to identify problematic cover areas and execute upon a plan of action to reduce exposure, change pricing and/or maximize profitability.

On the other hand, typical modern financial markets rely on a continuous double auction (CDA) transaction system to somewhat disburse or diversify risk and hedge against market fluctuations. The CDA model essentially allows any type of offer to be made at any time and type of transaction to take place when market conditions are right—a free market approach.

What is needed is an integrated risk placement platform offering cedants, brokers and/or Managing General Agents (MGAs) Underwriters (MGUs) to interact in a transparent or semi-transparent environment via the cloud and evaluate and conduct transactions when market conditions reach desired benchmarks—a re-insurance exchange akin to a stock exchange.

Additionally, a system that seamlessly integrates with existing enterprise systems and allows users to, within local system or within a virtual private network, establish private groups for parties having particular needs such that parties can transact business, share information or form a buying/selling pool is needed. More particularly, what is needed is a system that allows users to determine risk, exposure, pricing and profitability based on historical data and/or real time auction data. A system that functions similar to a traditional exchange where individual transaction and/or event (such as liability triggering events) can have near instantaneous impacts on future and/or concurrent transactions.

### BRIEF DESCRIPTION OF THE DRAWINGS

FIG. 1 depicts one embodiment of a cloud-based analysis system and trading exchange.

FIG. 2 depicts one embodiment of software running in a virtual private cloud environment, along with possible components.

FIG. 3 depicts one embodiment of cloud-to-cloud communication and software component processing across multiple clouds.

FIG. 4 depicts one embodiment of a data handling framework.

FIG. 5 depicts one embodiment of a high performance trading plant.

FIG. 6 depicts one embodiment of the steps performed by a risk optimization engine.

FIG. 7 depicts one embodiment of a reinsurance classification process.

FIG. 8 depicts one embodiment of a method for obtaining a pricing data set.

FIG. 9 depicts a reinsurance premium formula.

FIG. 10 depicts one embodiment of a pricing optimization method.

FIG. 11 depicts one embodiment of a cedant rating engine.

FIG. 12 depicts one embodiment of a reinsurer rating engine.

FIG. 13 depicts one embodiment of a broker rating engine.

FIG. 14 depicts one embodiment of a private group aggregate cloud, which is invitation-based.

FIG. 15 depicts another embodiment of a private group aggregate cloud, which is criteria-specific.

FIG. 16 depicts one embodiment of a method for creation of electronic slips.

FIG. 17 depicts one embodiment of a payment monitoring system performed by a billing/payments module.

FIG. 18 depicts one embodiment of a billing monitoring system performed by a billing/payments module.

FIG. 19 depicts one embodiment of a commutation system.

FIG. 20 depicts one embodiment of an automated recovery system method.

FIG. 21 depicts one embodiment of a cloud-based statutory filings system.

FIG. 22 depicts one embodiment of a statutory filing access process performed by a cloud-based statutory filings system.

FIG. 23 depicts one embodiment of a relational database process.

FIG. 24 depicts one embodiment of a computer system that can execute the sequences of instructions required to practice the invention.

FIG. 25 depicts one embodiment of a communications interface.

FIG. 26 depicts one embodiment of object-oriented programming.

### DETAILED DESCRIPTION

### Overview of Cloud-Based Analysis and Trading System

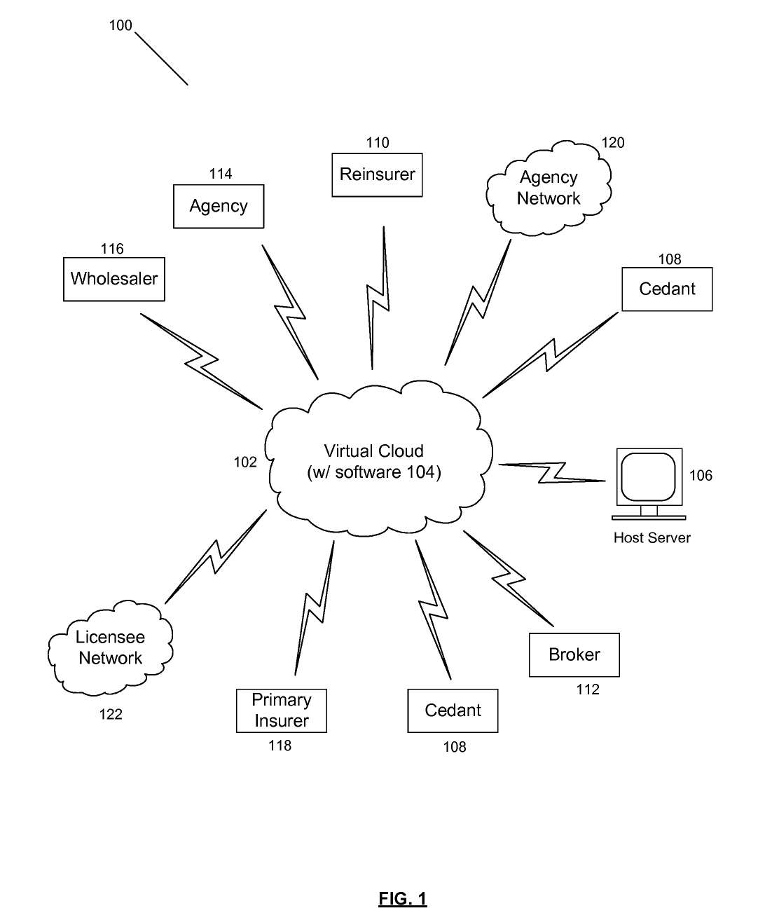

FIG. 1 depicts one embodiment of a cloud-based analysis and trading system 100 (hereinafter referred to as “system 100”). A system 100 can comprise a virtual cloud 102 running analysis and trading software 104 (hereinafter “software 104”) and comprising at least one host server 106. A virtual cloud 102 can be utilized by one or more cedants 108 (also known as an “insurer”), reinsurers 110, brokers 112, agencies 114, wholesalers 116, primary insurers 118, and/or any other appropriate party or entity. Moreover, in some embodiments, a virtual cloud 102 can be configured to communicate with one or more networks, such as an agency network 120, licensee network 122, or any other known or convenient type of network. Cedants 108, reinsurers 110, brokers 112, or any other desired party can communicate with a virtual cloud 102 via one or more wired and/or wireless communication interfaces and using one or more communications and/or networking protocols.

In some embodiments, a virtual cloud 102 can comprise additional servers or systems. A virtual cloud 102 can be private, but in other embodiments, a virtual cloud 102 can be a public or hybrid cloud, or any other known or convenient type of cloud. A cloud 102 can be configured as a virtual private cloud 102 via an integrated security component of a system 100.

### Software & Cloud Communication

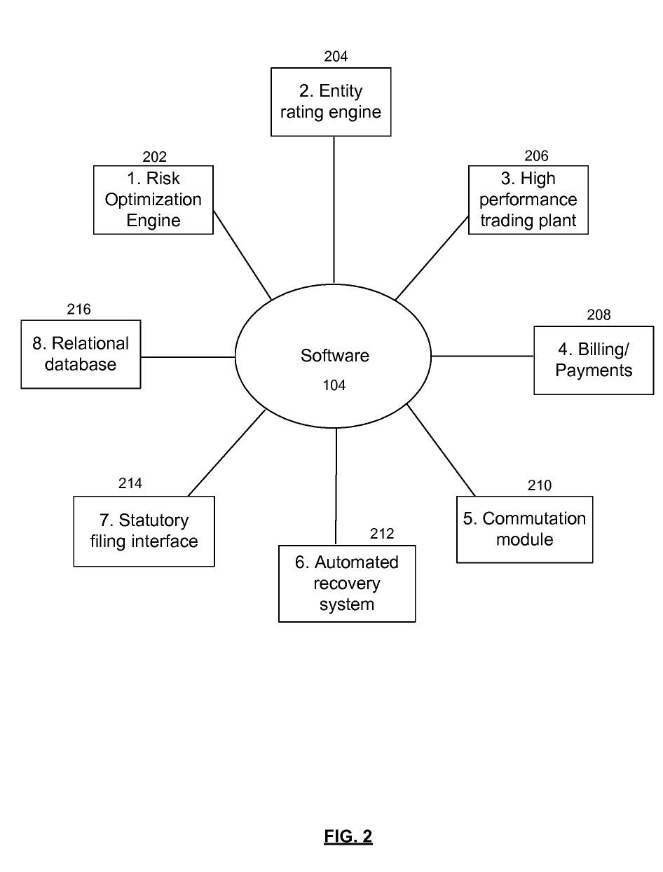

Referring to FIG. 2, software 104 can comprise several components, including: a risk optimization engine 202; an entity rating engine 204; a high performance trading plant 206; a billing & payments component 208; a commutation module 210; an automated recovery system 212; a statutory filing interface 214; and/or a relational database 216.

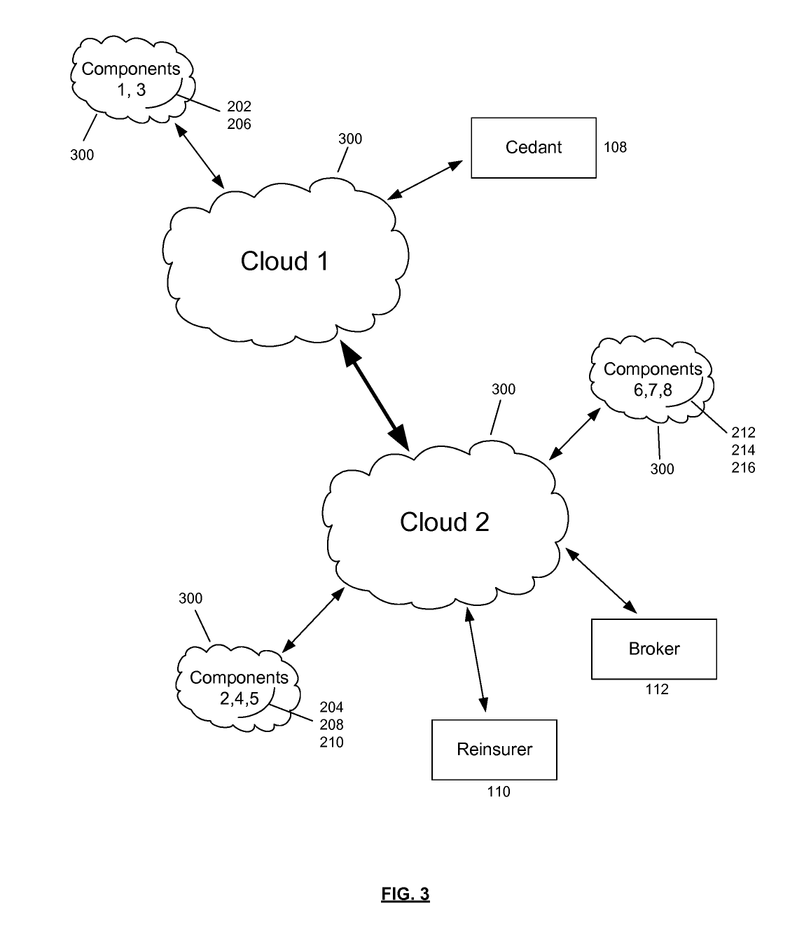

These components can be implemented within one cloud, but in some embodiments and as shown in FIG. 3, different components can be processed through two or more clouds 300. In FIG. 3, a risk optimization engine 202 and a high performance trading plant 206 can be processed in one cloud 300; an automated recovery system 212, statutory filing interface 214, and relational database 216 can be executed in another cloud 300; and an entity rating engine 204, billing/payments component 208, and commutation module 210 can be processed in yet another cloud 300. In other embodiments, any components of software 104 can be processed in any desired and/or appropriate number of clouds 300, which can communicate with each other. Furthermore, in some embodiments, a cedant 108, reinsurer 110, or broker 112 can communicate through one cloud 300, while another cedant 108, reinsurer 110, or broker 112 can communicate through another cloud 300, with both clouds 300 communicating with each other.

In some embodiments, a system 100 can have open application programming interfaces (APIs) and/or can be adapted to integrate information from external company websites, such as Advisen, LexisNexis, Marshall-Swift/Boeckh, comparative private rating sources, agency management systems, insurer and wholesaler agency portals, and/or policy and claims administration system. In some embodiments, a system 100 can even be adapted to manage or host these entities.

### High Performance Trading Plant

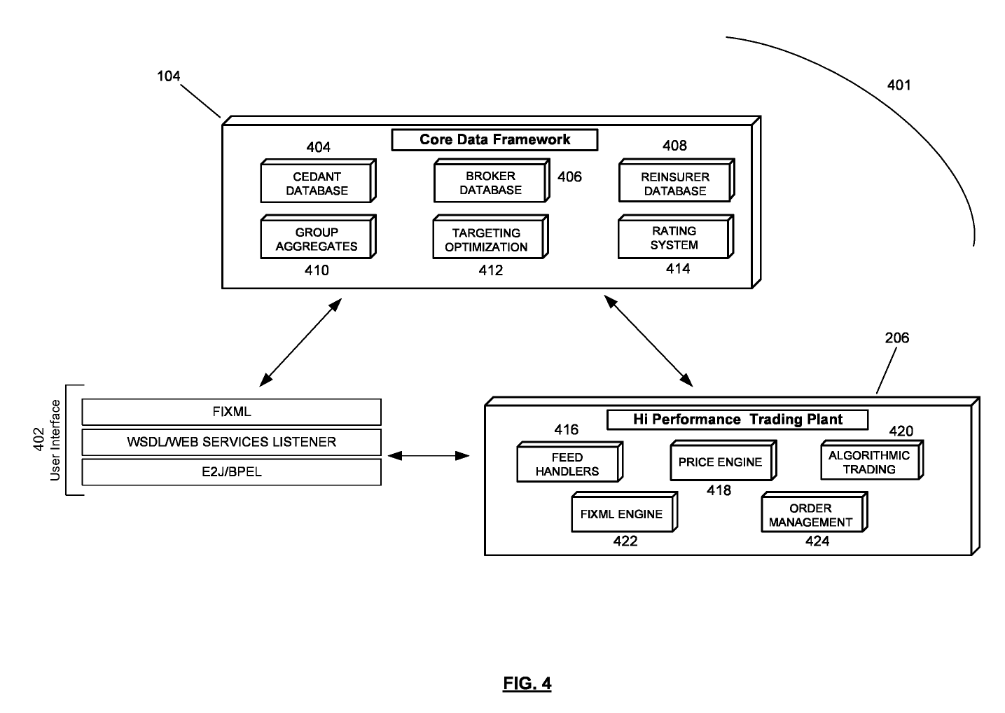

Referring to FIG. 4, one embodiment of a data handling framework 401 is depicted. Software 104 can communicate with a user interface 402 and/or a high performance trading plant 206. A user interface 402 can also perform data standardization, can utilize FIXML protocol, and can be comprised of Web Services Description Language format (WSDL) and WEB services listener, and/or Enterprise to Java/Business Process Execution Language (BPEL), and/or any other known or convenient programming language capable of manipulating a data set.

Software 104 can be a core data framework, and can be comprised of a cedant database 404, broker database 406, reinsurer database 408, group aggregates 410, targeting optimization 412, a rating system 414, and/or any other known and/or convenient component. Software 104 can communicate with a high performance trading plant 206 via a user interface 402, however in some embodiments, such as cloud to cloud, a user interface 402 may not be necessary and software 104 and a high performance trading plant 206 can communicate directly.

A high performance trading plant 206 can be adapted to connect to more than one virtual private exchange, or to connect to the system's 100 virtual exchanges, LLOYDS, or other exchanges. A high performance trading plant 206 can be comprised of feed handlers 416, a price engine 418, algorithmic trading engine 420, FIXML engine 422, order management engine 424, and/or any other known or convenient component. An algorithmic trading engine 420 can act to take specified action when certain criteria are met (for example, a stop loss-type order).

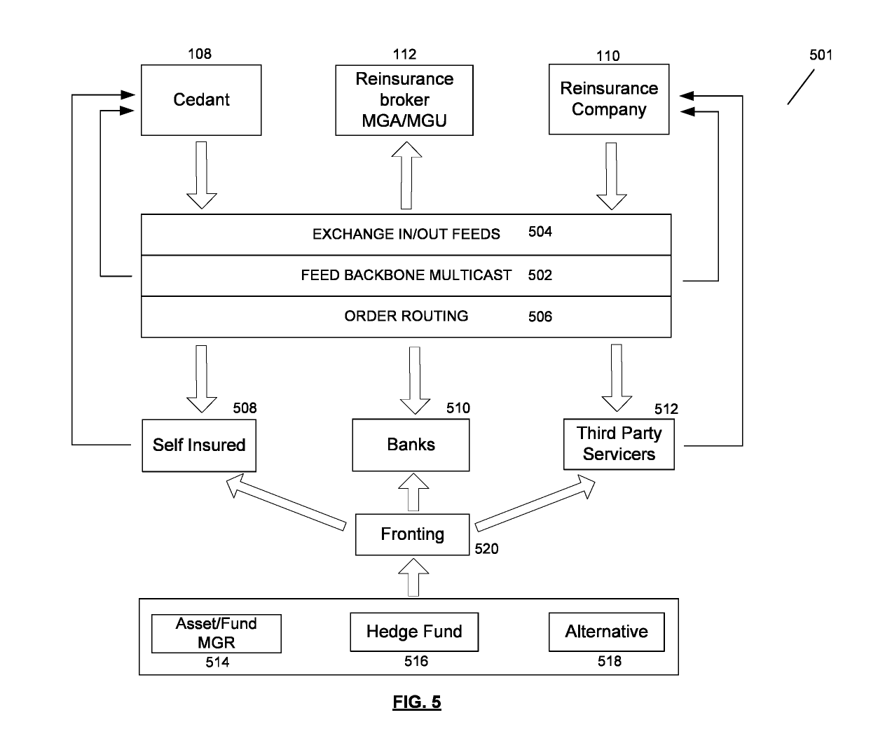

FIG. 5 depicts a view of one embodiment of a data exchange process 501 that can be produced by feed handlers 416, price engine 418, and/or FIXML engine 422 of a high performance trading plant 206, and/or any other known or convenient system. Data can be gathered from cedants 108 and/or reinsurers 110 and subsequently routed through a feed backbone multicast 502, which can evaluate proper routing of such information. The data can then be sent through an exchange feed 504 and/or order routing system 506 to reinsurance brokers 112, self-insured entities 508, banks 510, and/or third party servicers 512. In some embodiments, data can also be routed directly from a feed backbone multicast 502, self-insured entities 508, banks 510, and/or third party servicers 512 to cedants 108 and/or reinsurers 110.

Elasticity can be created by pushing the data of each distinct channel toward each other as an aggregator and then out through application programming interfaces to third parties who can evaluate the program. Upstream elasticity can be created by forming a new product channel for assent/fund managers 514, hedge funds 516, and/or alternative funds 518 to participate indirectly in the reinsurance process. These parties 514, 516, and 518 can participate in a fronting process 520 to finance self-insured entities 508, banks 510, and/or third party servicers 512 during the reinsurance process. In some embodiments, the high performance trading plant 206 can allow any type of user to interact with at least one other user and, if desired, to conduct and/or perform any type of insurance, reinsurance, underwriting, or other transaction or exchange associated with any type of known and/or convenient agreement.

### Risk Optimization Engine

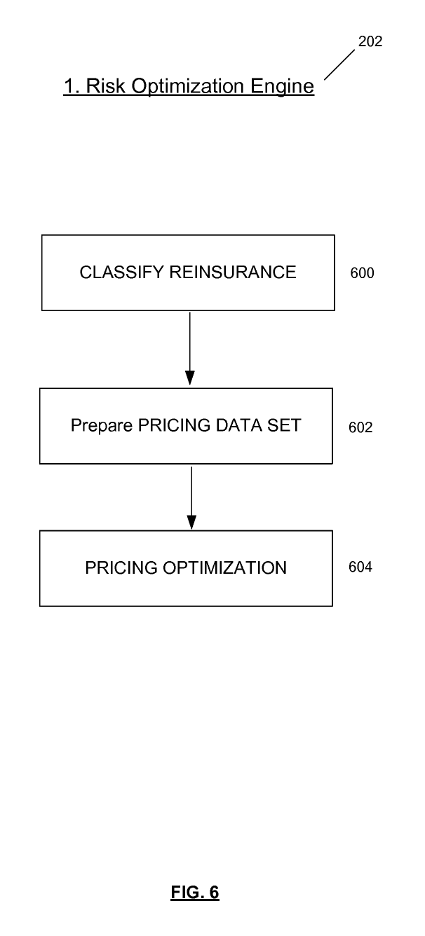

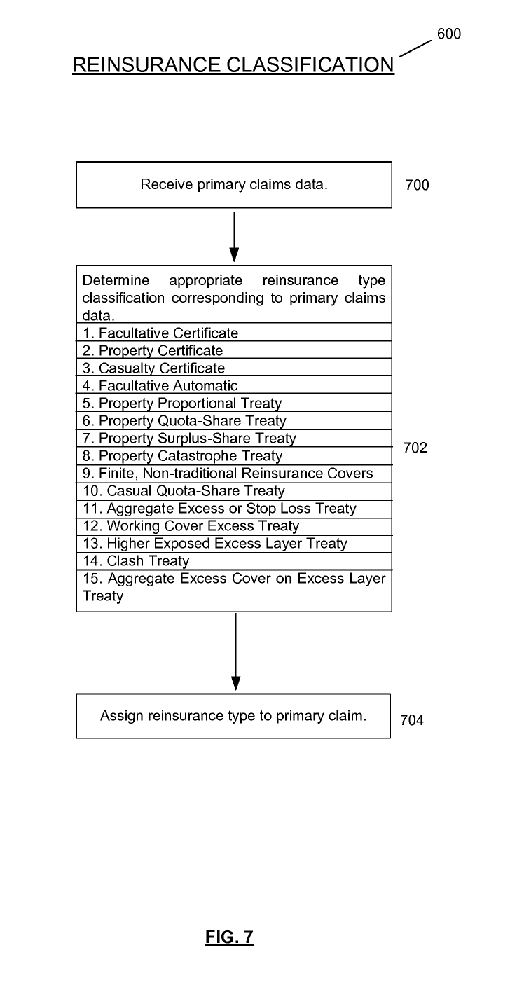

FIG. 6 depicts one embodiment of a risk optimization engine 202. First, at step 600, classification of reinsurance can be performed. At step 602, a pricing data set can be prepared. And at step 604, pricing optimization can take place. FIGS. 7-10 illustrate detailed embodiments of steps 600, 602, and 604.

Referring to FIG. 7, one embodiment of reinsurance classification 600 is described in detail. At step 700, primary claims data can be gathered. Primary claims data can include: insured information; value of policy; term of policy; types of coverage; and/or any other desired information. At step 702, primary claims data can then be used to determine an appropriate reinsurance type classification. Reinsurance types can include: Facultative Certificates; Property Certificates; Casualty Certificates; Facultative Automatic Certificate; Property Proportional Treaty; Property Quota-Share Treaty; Property Surplus-Share Treaty; Property Catastrophe Treaty; Finite, Non-Traditional Reinsurance Covers; Casual Quota-Share Treaty; Aggregate Excess or Stop Loss Treaty; Working Cover Excess Treaty; Higher Exposed Excess Layer Treaty; Class Treaty; and Aggregate Excess Cover on Excess Layer Treaty.

A Facultative Certificate can reinsure one primary policy, with its main purpose being to provide additional capacity. It can be used to cover part of specified large, especially hazardous or unusual exposures to limit their potential impact upon a cedant's net results or to protect a cedant's ongoing ceded treaty results in order to keep treaty costs down. A reinsurer can underwrite and accept each certificate individually, with the situation being very similar to primary insurance individual risk underwriting. A Property Certificate can be written on a proportional basis—the reinsurer can reimburse a fixed percentage of each claim on the subject policy. A Casualty Certificate can be written on an excess basis—a reinsurer can reimburse a share (for example, up to a specified dollar limit) of the part of each claim on the subject policy that lies above some fixed dollar attachment point (net retention).

A Facultative Automatic Agreement can reinsure many primary policies of a specified type. The primary policies can be very similar, so the exposure can be quite homogeneous. The main function of a Facultative Automatic Agreement can be to provide additional capacity, but since it covers many policies, it can also provide some degree of stabilization. A Facultative Automatic Agreement can be thought of as a collection of Facultative Certificates underwritten simultaneously. It can cover on either a proportional or excess basis. Usually, it is written to cover new or special programs marketed by a cedant, and a reinsurer may work closely with the cedant to design the primary underwriting and pricing guidelines. Facultative Automatic Agreements are normally written on a fixed cost basis, without the retrospective premium adjustments or variable ceding commissions sometimes used for treaties (discussed below).

In general, a treaty can reinsure a specified part of loss exposure for a set of insurance policies for a specified coverage period. For ongoing treaty coverage, the claims covered may be either those occurring during the treaty term or those occurring on policies written during the term. In the case of claims-made coverage, the word “occurring” can mean those claims made to the ceding company during the term. The premium subject to the treaty corresponds to the types of claims covered—it is earned premium arising from policies of the specified type either in force or written during the term of the treaty. The subject exposure is usually defined by Annual Statement line of business or some variant or subsets thereof. Because an ongoing treaty relationship involves a close sharing of much of the insurance exposure, it can create a close working partnership between the parties, and the expertise and services of the reinsurer or broker can be available to the cedant.

More specifically, primary claims data gathered in step 700 can be classified into one or more of several types of reinsurance treaties in step 702 (in addition to the aforementioned reinsurance types). Quota-Share and Surplus-Share treaties are types of Property Proportional treaties. A Quota-Share treaty reinsures a fixed percentage of each subject policy. Its main function is financial results management, although it also provides some capacity. The reinsurer usually receives the same share of premium as claims, and pays the cedant a ceding commission commensurate with the primary production and handling costs (underwriting, claims, etc.).

Quota-Share treaties usually assume in-force exposure at inception. A cedant's financial results can be managed because the ceding commission on the ceded unearned premium reserve transfers statutory surplus from the reinsurer to the cedant. The cession of premium also reduces the cedant's net-premium-to-surplus ratio. The ceding commission on Quota-Share treaties is often defined to vary within some range inversely to the loss ratio. This allows the cedant to retain better than expected profits, but protects the reinsurer somewhat from adverse claims experience.

A Surplus-Share treaty can also reinsure a fixed percentage of each subject policy, but the percentage can vary by policy according to the relationship between the policy limit and the treaty's specified net line retention. A Surplus-Share treaty's main function is capacity, but it can also provides some stabilization. A Surplus-Share treaty may also assume in-force exposure at inception, which together with a ceding commission provides some management of financial results.

Property Catastrophe treaties can reinsure catastrophic perils on a treaty basis. Property Catastrophe treaties are generally per-occurrence and used to protect the net position of the cedant against the accumulation of claims arising from one or more large events. It is usually stipulated that two or more insureds must be involved before coverage attaches. Coverage can include hurricane and windstorm, earthquake, flood, tornado, hail and fire; however, coverage for other perils may be negotiated on a case-by-case basis.

Finite or Non-Traditional reinsurance covers have evolved as the result of a growing trend to use reinsurance, especially treaties, to primarily or solely manage financial results. “Finite” means that the reinsurer's assumed risk is significantly reduced by various contractual conditions (and the reinsurer's expected margin is also reduced to reflect this reduced risk transfer).

With Aggregate Excess treaties, sometimes called Stop Loss treaties, a loss is the accumulation of all subject losses during a specified time period (e.g., 1 year). It usually covers all or part of the net retention of a cedant and protects net results, providing very strong stabilization. Claims arising from natural catastrophes can be excluded, or there may be a per-occurrence maximum limit.

A Working Cover Excess treaty reinsures an excess layer for which claims activity is expected each year. The significant expected claims frequency creates some stability of the aggregate reinsured loss. As a result, Working Covers can be retrospectively rated, with the final reinsurance premium partially determined by the treaty's loss experience.

A Higher Exposed Excess Layer treaty attaches above the Working Cover(s), but within policy limits. Thus there is a direct single-policy exposure to the treaty. A Clash treaty is a casualty treaty that attaches above all policy limits. Thus it may be only exposed by: extra-contractual obligations (i.e., bad faith claims); excess-of-policy-limit damages (an obligation on the part of the insurer to cover losses above an insurance contract's stated policy limit); catastrophic workers compensation accidents; the “clash” of claims arising from one or more loss events involving multiple coverages or policies. The above-described reinsurances types are only exemplary and any other known or convenient reinsurance type can be used in the classification step 702.

Once primary claims data is compared to reinsurance types at step 702, in step 704 the classification determination (an appropriate reinsurance type) can be assigned to the primary claim associated with the primary claims data.

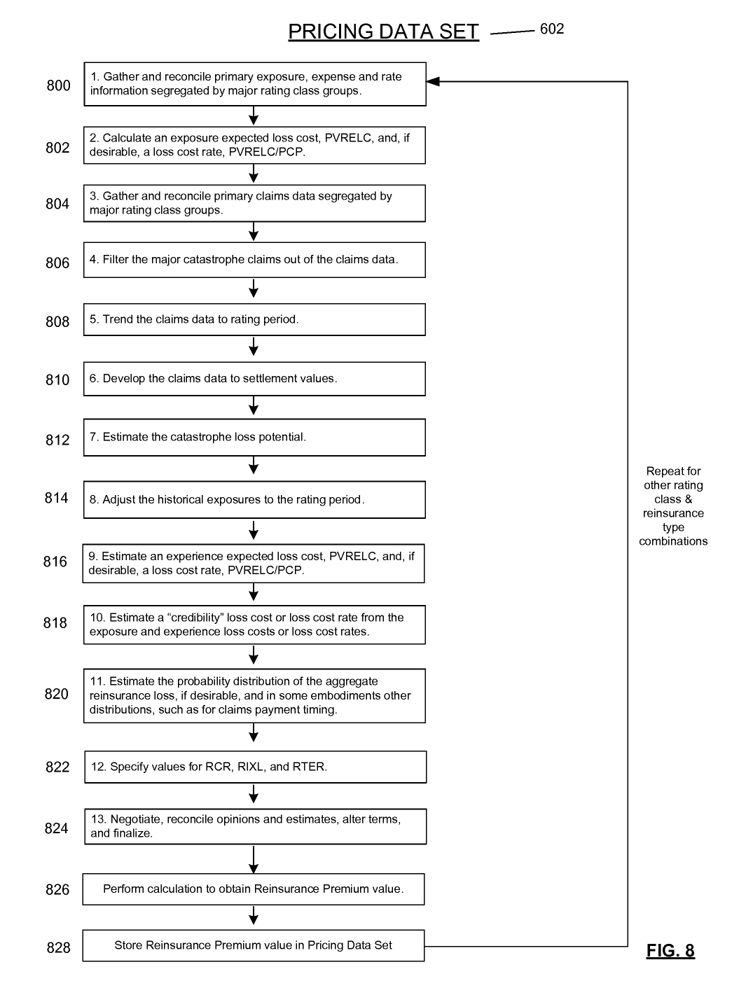

FIG. 8 depicts one embodiment of the steps to determining a pricing data set 602. In general, when pricing reinsurance, it is desirable to perform both an exposure rating and an experience rating. An exposure rating is akin to a primary manual rate, using general rating factors independent of the cedant's particular claims experience. An experience rate is akin to a primary loss rate, completely dependent upon the cedant's particular claims experience. The final technical rate/pricing data set 602 will be a weighing together of both of these rates.

At step 800, primary exposure, expense and rate information can be gathered, reconciled, and segregated by major rating class groups. The grouping can be by Annual Statement line of business, or could be a finer decomposition if the proposed reinsurance coverage is more restricted or if there are any important exposures that should be evaluated separately. For reinsurance purposes, the word “exposure” means primary subject premiums. Reconciliation of information can be to publish financial records as much as possible. If there is significant catastrophe potential, the exposure can be by zip code.

As a non-limiting example of step 800, suppose a proposed treaty is to cover the property exposures in an Annual Statement lines 1-5 and 12, net of facultative reinsurance, with liability parts of lines 3-5 excluded. In this example, the reinsurer would ask for gross written premium by line by year for 1995 through Jun. 30, 2000, together with estimates for 2000 and 2001. The expensive information could be from the cedant's Insurance Expense Exhibit. The rate information would be contained in the cedant's underwriting line guide. Average rate deviations could also be collected.

At step 802, an exposure expected loss cost, PVRELC, can be calculated, along with a loss cost rate, PVRELC/PCP, if desirable. For proportional coverage, an exposure loss cost rating can simply be an evaluation of the adequacy of a cedant's rates for the exposures to be covered, leading to an estimate of the expected loss ratio. An underwriting review can compare the cedant's rates to those of other primary insurers or to the reinsurer's own database of adequate primary rates.

Many people in the reinsurance business would say that you cannot calculate an exposure rate for proportional coverage, or that you cannot rate the coverage at all; you can only evaluate the ceding commission. The ceding commission should fairly reimburse the cedant's expenses, but should not put the cedant into a position significantly more advantageous than that of the reinsurer. Except in unusual circumstances, the cedant should not make a significant profit while the reinsurer is losing money, and vice versa. The point here is to evaluate the (in)adequacy of the cedant's rates in order to evaluate whether or not the proposed reinsurance commission will work for the reinsurer and for the cedant.

At step 804, primary claims data can be gathered, reconciled, and segregated by major rating class groups. We want the claims data segregated as the exposure data. We usually want Allocated Loss Adjustment Expense (ALAE) separate from indemnity losses. For proportional coverage, the data are usually historical aggregate claims data for the past five to ten policy years, plus individual large claims. We also want some history of claims values (a historical policy year/development year triangle) for step 808 (discussed below). The data should be adjusted so that they are approximately on the same basis as our coverage with respect to any other inuring reinsurance, that is, reinsurance that applies to the cedant's loss before our coverage.

At step 806, major catastrophe claims can be filtered out of the primary claims data by subtracting the numbered catastrophe values by line at each evaluation from the loss development triangles.

Step 808 can trend claims data to the rating period. It is important to be sure that the historical claims data is adjusted in a manner that makes it reasonably relevant to the rating period. The trending can be for inflation and for other changes in exposure (such as higher policy limits) that might affect the loss potential. For proportional coverage, this step can be skipped and one can simply look for any apparent trend in the historical loss ratios in step 816 (discussed below).

At step 810, claims data can be developed into settlement values. Claims development is usually not much of a problem for filtered primary property claims. If historical policy year/development year triangles are available, standard methods can be used to estimate loss development factors and apply these to the filtered data. If historical triangles are not available, an Annual Statement Schedule P accident year data may be used (if it is reasonably reflective of the proposed coverage and if major catastrophes can be filtered out) to estimate policy year loss development factors. Development patterns estimated from the cedant's data can also be compared to expectations based upon historical data for comparable coverages to check for reasonableness. If the reinsurer believes that the development patterns should be reasonably similar for the various covered lines, we usually estimate the total development from the combined data instead of by line.

At step 812, catastrophic loss potential can be estimated. At step 814, the historical exposures can be adjusted to the rating period. The goal here is to be sure that the historical exposure (premium) data is adjusted in a manner that makes it reasonably relevant to the rating period. The trending can be for primary rate and underwriting changes and for other changes in exposure that might affect the loss potential.

At step 816, an experience expected loss cost, PVRELC, can be estimated, and, if desired, a loss cost rate, PVRELC/PCP, can also be estimated. At step 818, a “credibility” loss cost or loss cost rate from the exposure and experience loss costs or loss cost rates can be estimated. At step 820, the probability distribution of the aggregate reinsurance loss can be estimated, if desirable, and in some embodiments other distributions (such as for claims payment timing) can be estimated. At step 822, values for Reinsurance Ceding Commission Rate (RCR), Reinsurer's Internal Expense Loading (RIXL), and Reinsurer's Target Economic Return (RTER) can be specified.

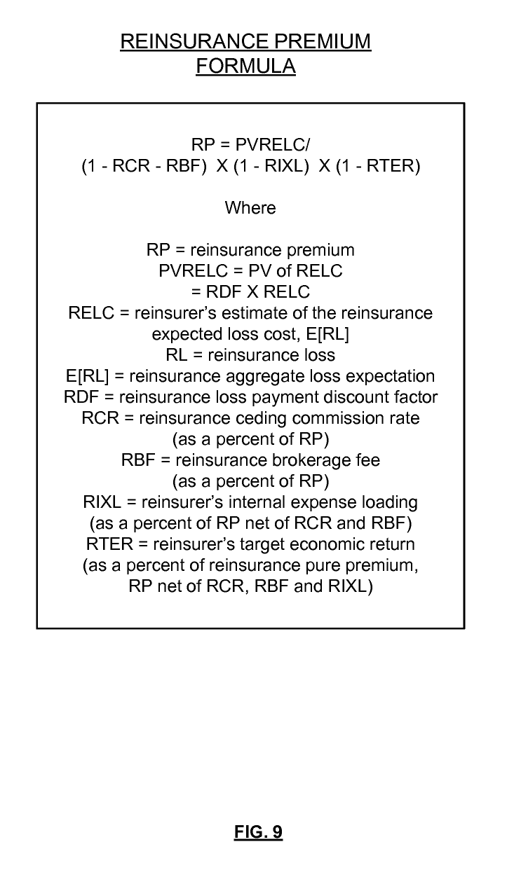

At step 824, opinions and estimates can be negotiated and reconciled, and terms can be altered and finalize. Following step 826, a reinsurance premium value can be calculated by using the reinsurance premium formula in FIG. 9. This reinsurance premium value can then be stored in the Pricing Data Set at step 828. Steps 800-828 can be repeated for other rating class and reinsurance type combinations. In some embodiments, the aforementioned steps can be implemented in real time as data is inputted by a user or retrieved by the system 100.

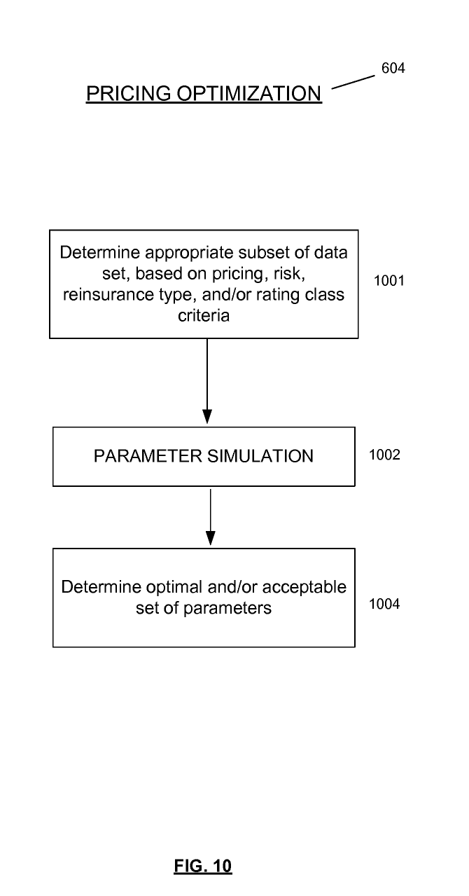

Referring to FIG. 10, the final step in one embodiment of a risk optimization engine 202 can be pricing optimization 604. At step 1001, an appropriate subset of the pricing data set can be determined, using pricing, risk, reinsurance type, and/or any other desired rating class criteria. This subset can then be used to create the pricing conditions that the strategy is to be used against. Parameter simulation can be conducted at step 1002. Subsequently, at step 1004, an optimal and/or acceptable set of parameters can be determined.

### Entity Rating Engine

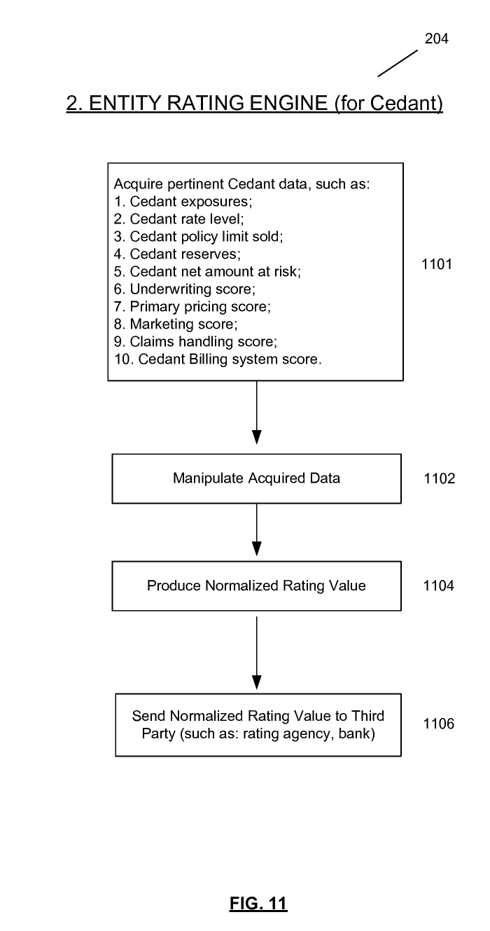

Turning to FIGS. 11-13, in some embodiments, software 104 can further comprise an entity rating engine 204. FIG. 11 depicts one embodiment of a cedant rating engine 204. In step 1101, cedant data can be acquired, such as, but not limited to: cedant exposures; cedant rate level; cedant policy limit sold; cedant reserves; cedant net amount at risk; underwriting score; primary pricing score; marketing score; claims handling score; and cedant billing system score. At step 1102, the acquired cedant data can be manipulated as desired. At step 1104, a normalized rating value can be produced. At step 1106, the normalized rating value can be sent to a third party, such as, but not limited to, a rating agency or bank. The aforementioned steps can be implemented in real time as data is acquired by a system 100 and/or the entity rating engine 204. Moreover, the steps can be performed in any known and/or convenient order, and steps can be added, removed, and/or changed as desired.

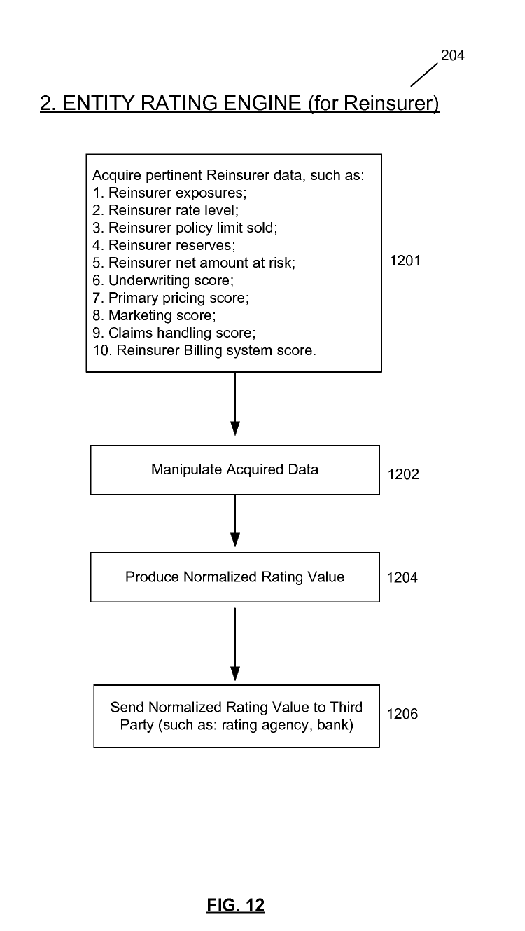

FIG. 12 depicts one embodiment of a reinsurer rating engine 204. In step 1201, reinsurer data can be acquired, such as, but not limited to: reinsurer exposures; reinsurer rate level; reinsurer policy limit sold; reinsurer reserves; reinsurer net amount at risk; underwriting score; primary pricing score; marketing score; claims handling score; and reinsurer billing system score. At step 1202, the acquired reinsurer data can be manipulated as desired. At step 1204, a normalized rating value can be produced. At step 1206, the normalized rating value can be sent to a third party, such as, but not limited to, a rating agency or bank.

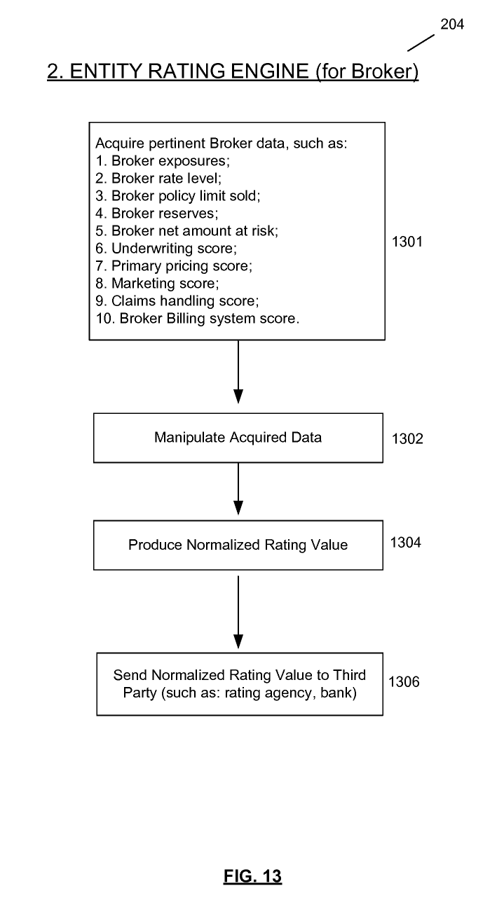

FIG. 13 depicts one embodiment of a broker rating engine 204. In step 1301, broker data can be acquired, such as, but not limited to: broker exposures; broker rate level; broker policy limit sold; broker reserves; broker net amount at risk; underwriting score; primary pricing score; marketing score; claims handling score; and broker billing system score. At step 1302, the acquired broker data can be manipulated as desired. At step 1304, a normalized rating value can be produced. At step 1306, the normalized rating value can be sent to a third party, such as, but not limited to, a rating agency or bank.

### Group Aggregates

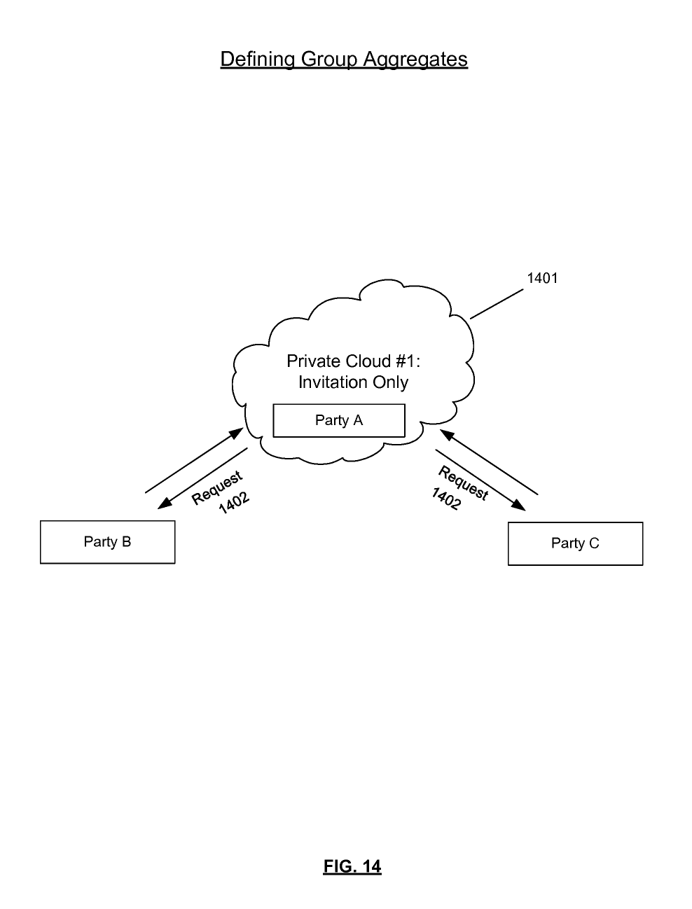

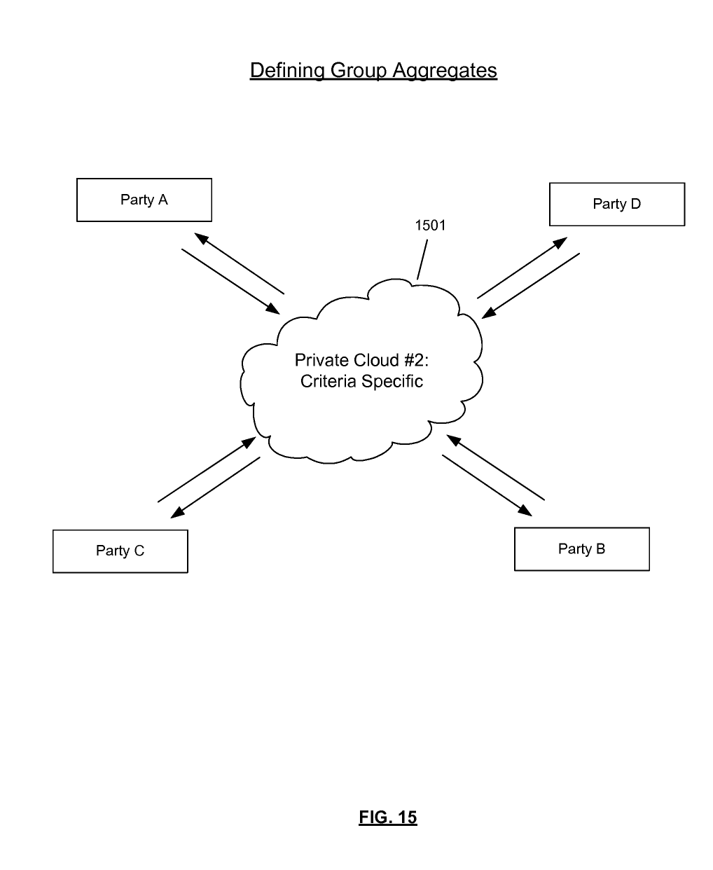

Referring to FIGS. 14-15, in some embodiments a system 100 can allow for the selective creation of group aggregates in private clouds. Among other things, group aggregates can be utilized for offsetting risk by allowing parties to hedge risk on one or more insurance or reinsurance policies. In some embodiments of a system 100, certain data can be available for any user to view, making it feasible to create group aggregates. FIG. 14 depicts one embodiment of a private, invitation-only group aggregate cloud 1401. Party A (a cedant, broker, reinsurer, or other user) can create their own virtual private cloud 1401 and send out requests or invitations 1402 to Party B, Party C, or any other know or convenient person or entity. Party B and Party C can then communicate with the private cloud 1401, either denying or accepting the invitation 1402. In some embodiments, invitees can be allowed to view data related to the insurance or reinsurance policy for which they are being invited to join prior to accepting or denying the invitation 1402.

FIG. 15 depicts another embodiment of a private group aggregate cloud 1501, however in this embodiment parties can join only if they meet pre-determined criteria. Such criteria can include entity rating, entity size, and funds available.

In some embodiments of a system 100, a user can be allowed to commission or de-commission as many private group aggregate clouds as desired. In some instances, parties may use private group aggregate clouds to swap risk on existing policies, or to simply exchange pricing information. Moreover, any known, convenient, or desired person or entity can be allowed to utilize private group aggregate clouds. By utilizing private group aggregates, a party can greatly increase market share and velocity.

### Electronic Slips

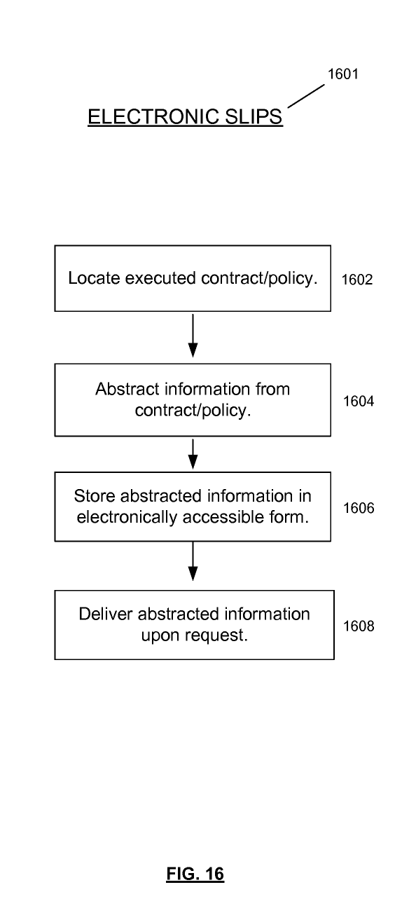

Referring to FIG. 16, electronic slips 1601 can be created and utilized as an electronic proxy of an existing contract, policy, or cover. This allows for abstracting information without identifying confidential pieces of information, such as the contracting parties or the renewal or expiration cycle. Electronic slips 1601 can also allow the market to set a notional value to the slip 1601 over the life of the contract and permit reinsurers (or any other desired party) to engage in swaps to hedge against price swings or volatility. In some embodiments, third parties can bid on a policy to take over upon expiration or renewal. This can all be done without affecting the underlying policies or contracts and does not change reserve requirements.

An electronic slip 1601 can be created by first locating an executed contract or policy (step 1602). Then, information can be abstracted from the contract or policy in step 1604. The abstracted information can be stored in electronically accessible form (step 1606) and then delivered upon request (step 1608). In some embodiments, only a party to a contract or policy can request an electronic slip 1601. In other embodiments, third parties can request an electronic slip 1601. In yet other embodiments, one or more parties to a contract or policy can limit viewing of an electronic slip 1601 to chosen third parties or third parties that meet specified criteria (such as based on entity rating or funds availability). In some embodiments, a high performance trading plant 206 can request an electronic slip 1601.

### Billing/Payments

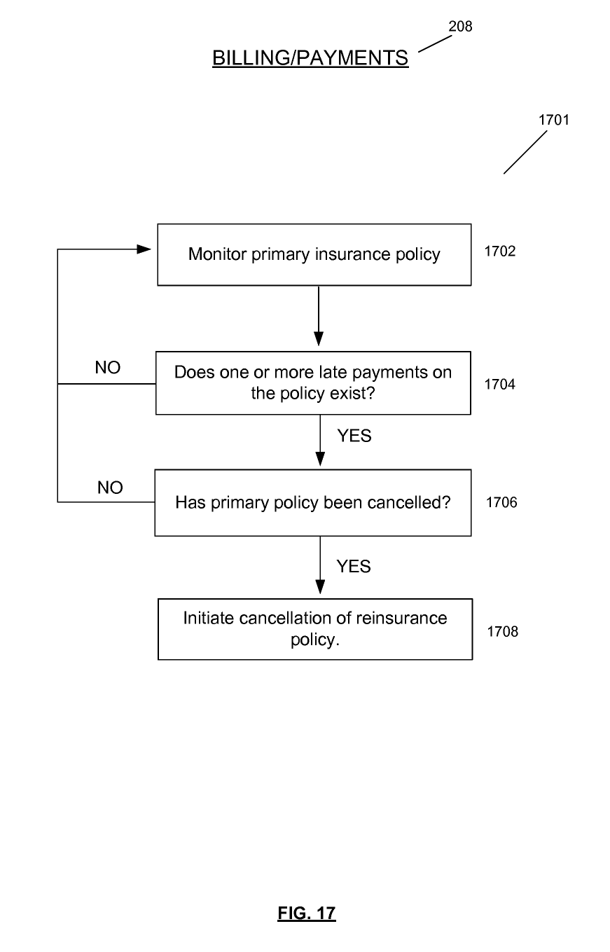

Software 104 can further comprise a billing and payments component 208, which can automate policy administration. The billing and payments component 208 can have one or more functions. One embodiment of a billing and payments component 208 function is depicted in FIG. 17. A payment monitoring system 1701 can comprise several steps. At step 1702, a primary insurance policy can be monitored. At step 1704, the system 1701 can determine whether one or more late payments on the policy exist. If ‘NO’, the system 1701 can return to step 1702 and continue to monitor the policy. If ‘YES’, at step 1706 the system can determine whether the primary policy has been cancelled. If ‘NO’, the system 1701 can return to step 1702 and continue to monitor the policy. If ‘YES’, at step 1708 the system 1701 can initiate cancellation of the reinsurance policy associated with the primary insurance policy. The aforementioned payment monitoring system 1701 can also be implemented for monitoring reinsurance policies or any other known or convenient policy or contract.

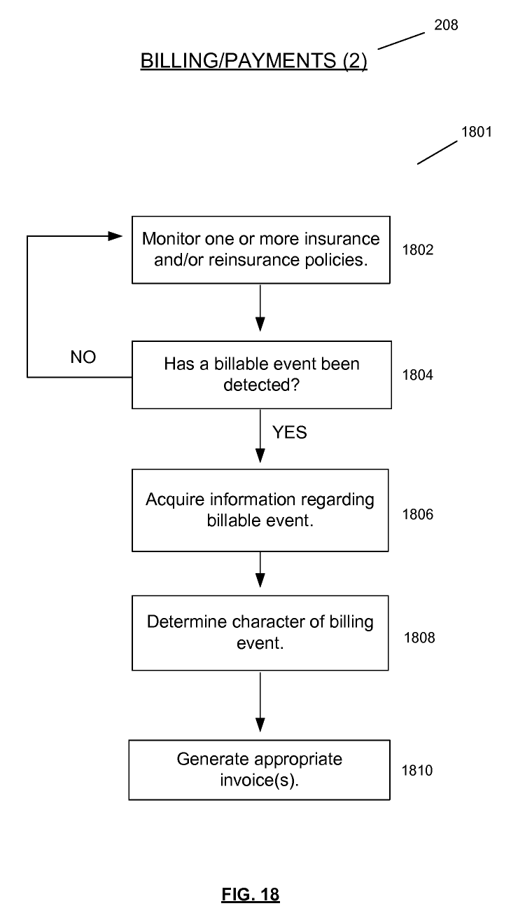

One embodiment of a billing monitoring system 1801 is depicted in FIG. 18. At step 1802, one or more insurance and/or reinsurance policies can be monitored. At step 1804, the system 1801 can determine whether a billable event has occurred. If ‘NO’, the system 1801 can return to step 1802 and continue to monitor the policy or policies. If ‘YES’, at step 1806, information about the billable event can be acquired. Subsequently, at step 1808 the system 1801 can determine the character of the billing event. Finally, appropriate invoices can be generated (step 1810).

By transferring coverage and reinsurance data to the hosted server 106 in a cloud 102 (see FIG. 1), a billing and payments component 208 can also calculate the premium due on a policy and cross-check it for accuracy with a user's home database. Additionally, the net amount at risk can be calculated and displayed on request at any day in a payment cycle, and summary accounting can be performed. In some embodiments, the aforementioned steps can be performed in an alternate sequence and/or steps can be added or removed from the process.

### Commutation

In some embodiments, software 104 can further comprise a commutation module 210, which can automate the reinsurance commutation process (or any other desired contract commutation process) and reduce time and costs associated with it. A reinsurance commutation is essentially an early termination of a contract of reinsurance in return for a mutually agreed upon level of consideration. The parties to the commutation agreement generally intend to terminate the agreement and to “unwind” the reinsurance transaction to a mutually agreed “as of” effective date. After the commutation is complete, there is no ongoing reinsurance cover in place and the future risks are borne on a net basis to the cedant. It is possible that a new reinsurer may be brought in to handle the prospective risks through a new reinsurance agreement; however, this is not always the case.

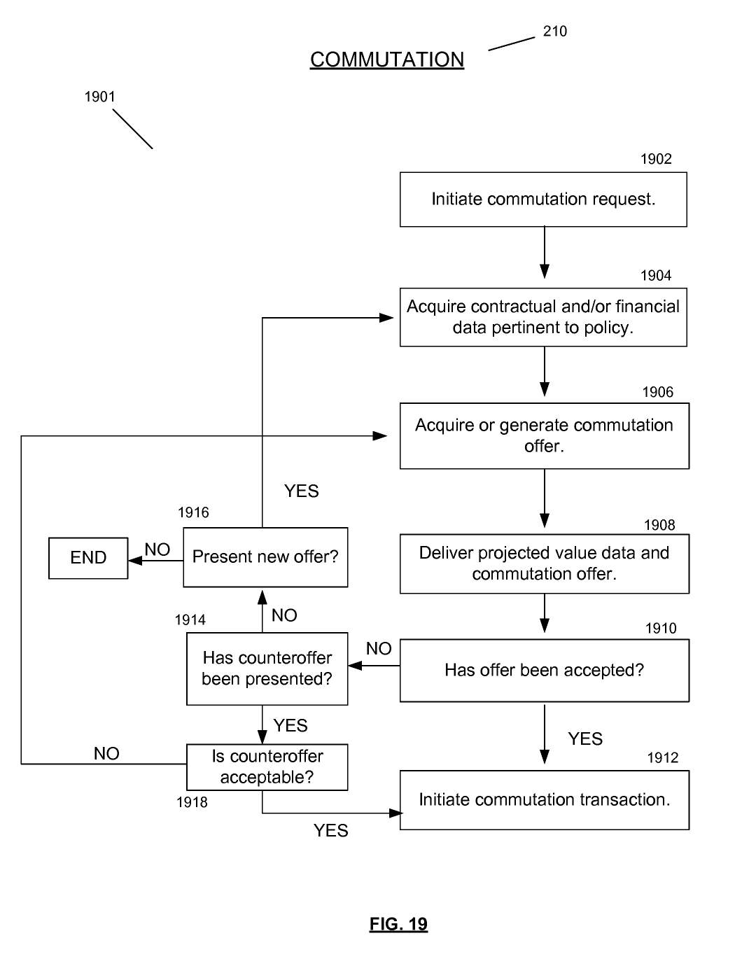

FIG. 19 depicts one embodiment of a commutation system 1901. First, at step 1902, a commutation request can be initiated. The request can be made by either party to a contract, or by a designated third party. At step 1904, contractual and/or financial data pertinent to the policy at hand can be acquired. A commutation offer can then be acquired or generated at step 1906, and the commutation offer, along with projected value data, can be delivered at step 1908. The system 1901 can then determine whether the offer has been accepted (step 1910). If ‘YES’, a commutation transaction can be initiated at step 1912. If ‘NO’, the system 1901 can determine whether a counteroffer has been presented. If ‘NO’, determine whether to present a new offer (step 1916). If a new offer will be presented, return to step 1904 to acquire appropriate data. If a new offer will not be presented, the commutation process can END.

If a counteroffer has been presented at step 1914, then at step 1918 it can be determined whether the counteroffer is acceptable. If ‘NO’, return to step 1906 to acquire or generate a new commutation offer. If ‘YES’, a commutation transaction can be initiated at step 1912. The aforementioned steps are merely exemplary of one embodiment of a commutation system 1901. In other embodiments, any other known and/or convenient steps and/or order can be implemented. In some embodiments, the aforementioned steps can be performed in an alternate sequence and/or steps can be added or removed from the process.

### Automated Recovery System

Software 104 can further comprise an automated recovery system 212. The system 212 can automate at least a portion of the claims process when a covered event occurs. At step 2001, a recovery session 2001 can be initiated. A recovery session can be initiated upon manual request by a cedant, when a cedant indicates that a covered event has occurred, or when a cedant or any other known or convenient entity triggers a recovery session via any other known or convenient event. At step 2002, the appropriate insurance policy and corresponding reinsurance policy can be identified. At step 2004, the covered event can be classified. Subsequently, at step 2006, policy coverage details can be determined. At this point, the system 212 can perform liability analyses. At step 2008, reinsurer liability can be determined. In some embodiments, communication with a relational database 216 can aid the process. Once reinsurer liability is determined, a reinsurance claim can be initiated at step 2010. Subsequently, information can be consolidated and presented for payment by a reinsurer (step 2012).

In addition to or in lieu of step 2008 (determining reinsurer liability), a system 212 can determine cedant liability at step 2007. Communication with a relational database 216 can aid this process. Once cedant liability is determined, a cedant can reconcile a claim with an insured (step 2009). Subsequently, information can be consolidated and presented for payment by a reinsurer (step 2012). In other embodiments, any other known and/or convenient steps and/or order can be implemented.

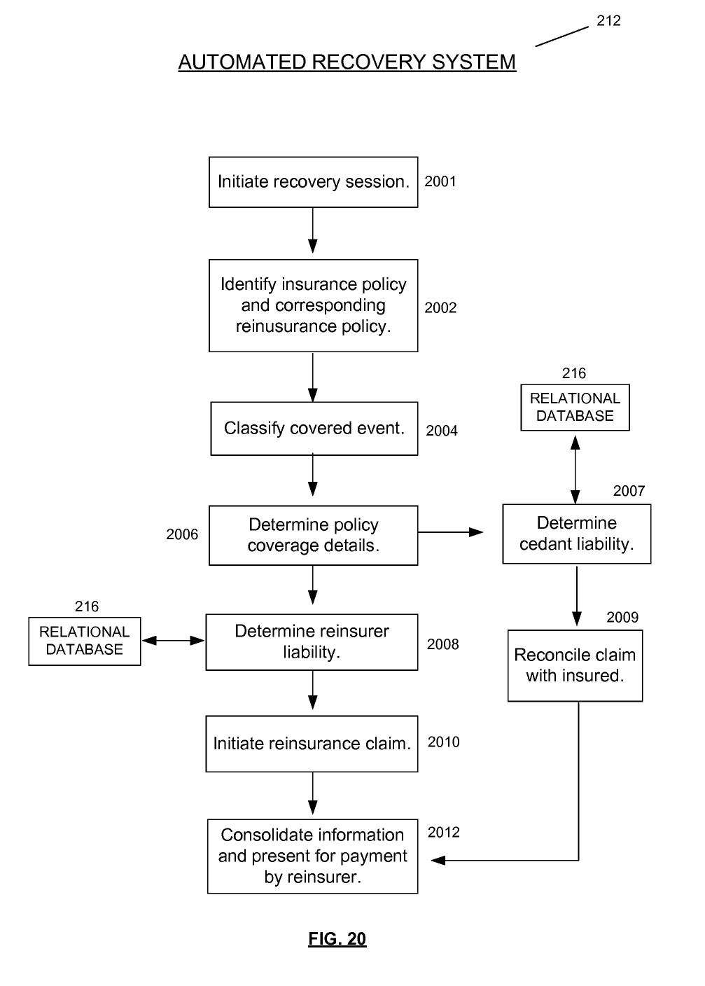

In some embodiments, an automated recovery system 212 can be utilized to simulate loss risks and exposures. Simulated data representing fictitious scenarios can be plugged into the method described in FIG. 20 (or any desired variant thereof). Resulting information can then be fed back to a risk optimization engine 202, high performance trading plant 206, and/or any other software 104 component, for premium pricing purposes. In some embodiments, the aforementioned steps can be performed in an alternate sequence and/or steps can be added or removed from the process.

### Statutory Filings

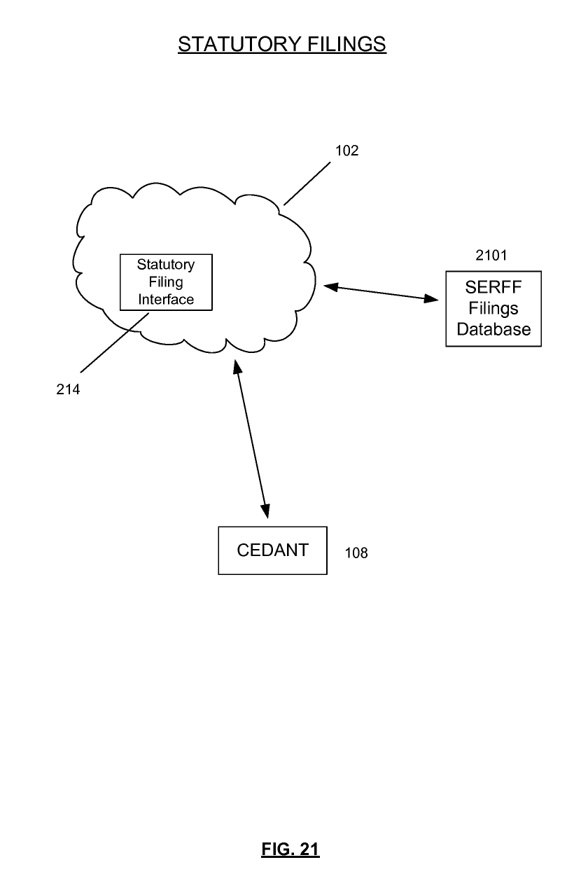

Software 104 can further comprise a statutory filing interface 214. As shown in FIG. 21, a cedant 108 (or reinsurer 110, broker 112, or any other desired party) can access a System for Electronic Rate and Form Filing (SERFF) database 2101 through a virtual private cloud 102, thereby providing a user with a central dashboard that can have tracking, navigation, search, export, electronic funds transfer (EFT) and application programming interface (API) capabilities, as well as state-specific data field views. Data fields can include company tracking number, company tracking status, date of company status change, SERFF tracking number, date of SERFF status change, reviewer name and contact information, state transfer of information (TOI), state status, status change, date of state status change, delivery dsate, disposition date, implementation date, state contact information, and/or any other know or convenient field.

In some embodiments, a statutory filing interface 214 can provide a transmittal header that can be used with electronic filings and can have audit, log file, attachment, and/or cover letter abilities. A central dashboard can also provide views of message, audit, and/or log files. Moreover, documents can be viewed, retrieved, or printed by the following fields: closed by state, closed by filing date, closed by SERFF tracking number, closed by Company tracking number, draft by date, draft by state, draft by Company tracking number, draft/multi state, draft/submission, submitted by fields, and/or any other known or convenient field. In some embodiments, a cedant 108 or other user can perform advanced searches on the central dashboard by: transfer of information (TOI), filing and document type, and/or any other known or convenient parameter.

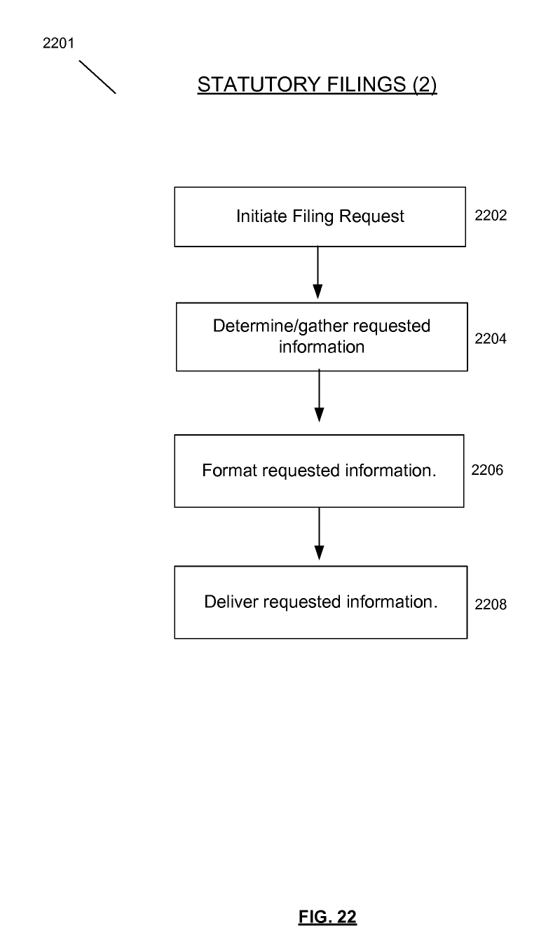

FIG. 22 illustrates one embodiment of a statutory filing access process 2201. First, at step 2202, a filing request can be initiated by a cedant, reinsurer, broker, or any other desired party. At step 2204, requested information can be determined and/or gathered. At step 2206, the requested information can be formatted. Finally, at step 2208, the requested information can be delivered. In other embodiments, any other known and/or convenient steps and/or order can be implemented. In some embodiments, the aforementioned steps can be performed in an alternate sequence and/or steps can be added or removed from the process.

### Relational Database

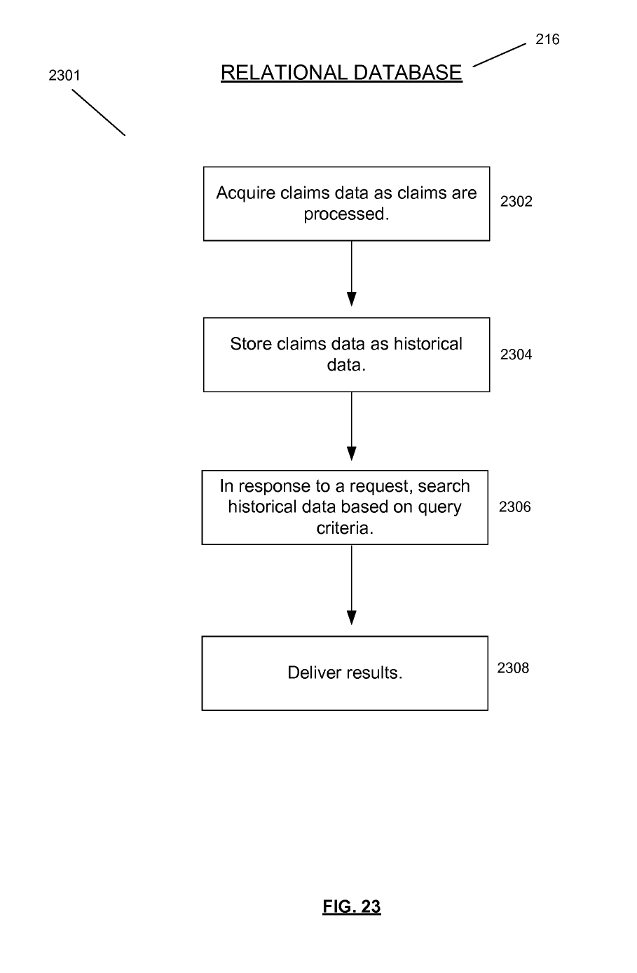

Software 104 can further comprise a relational database 216. One embodiment of a relational database process 2301 is illustrated in FIG. 23. At step 2302, claims data can be acquire as claims are processed. At step 2304, the claims data can be stored as historical data. In response to a request, historical data can be searched based on query criteria (step 2306). Query criteria can be a specified claims time period, class ratings, entity ratings, or any other desired parameter. At step 2308, the results of the search, results can be delivered.

In some embodiments, the results of a relational database process 2301 can be manipulated to determine the relationship between relevant data. By way of non-limiting example, the variation in premiums can be calculated in terms of variation of risk. In other embodiments, other variants can be compared in any desired relationship. In some embodiments, any data set, chart, or other result of a relational database process 2301 and/or manipulation can be utilized by a risk optimization engine 202, high performance trading plant 206, or any other known or convenient component of software 104 and/or a system 100.

In some embodiments, a relational database 216 can store personal profiles of users and/or can have a business rules registry. A business rules registry can govern submission data and content permissions, submission routing permissions, and/or transaction party permissions. In some embodiments, personal profiles can be adapted to store rules preferences for future use. Moreover, in some embodiments, one or more of the aforementioned steps can further comprise a processing sub-step, whereby one or more of the processes that can be performed by software 104 (or any other known or convenient process) can be implemented prior to transmitting results or other data.

### Hardware Implementation

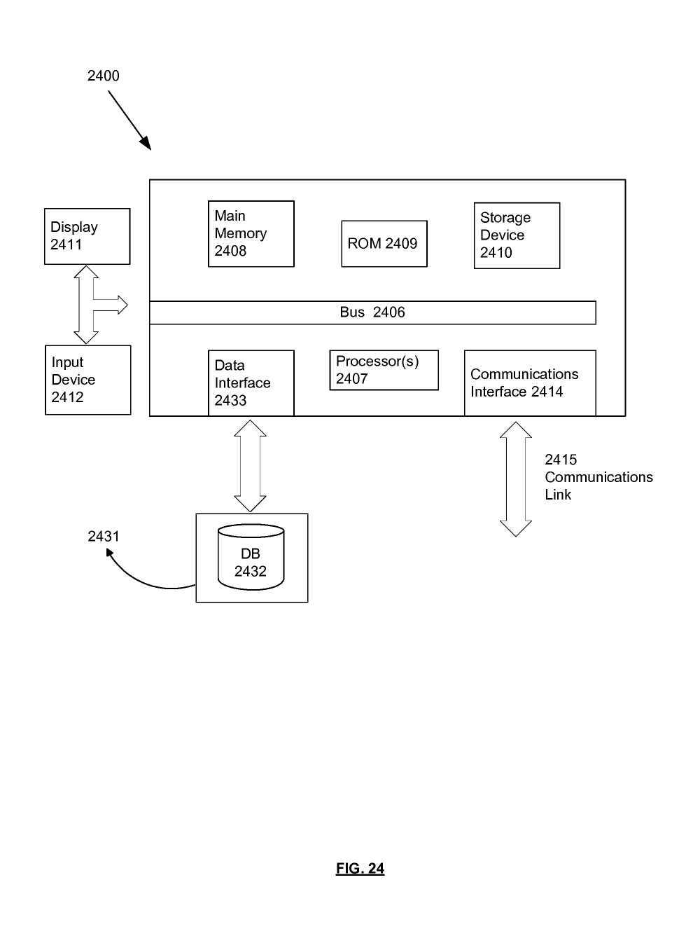

The execution of the sequences of instructions required to practice the embodiments may be performed by a computer system 2400 as shown in FIG. 24. In an embodiment, execution of the sequences of instructions is performed by a single computer system 2400. According to other embodiments, two or more computer systems 2400 coupled by a communication link 2415 may perform the sequence of instructions in coordination with one another. Although a description of only one computer system 2400 will be presented below, however, it should be understood that any number of computer systems 2400 may be employed to practice the embodiments.

A computer system 2400 according to an embodiment will now be described with reference to FIG. 24, which is a block diagram of the functional components of a computer system 2400. As used herein, the term computer system 2400 is broadly used to describe any computing device that can store and independently run one or more programs.

Each computer system 2400 may include a communication interface 2414 coupled to the bus 2406. The communication interface 2414 provides two-way communication between computer systems 2400. The communication interface 2414 of a respective computer system 2400 transmits and receives electrical, electromagnetic or optical signals, that include data streams representing various types of signal information, e.g., instructions, messages and data. A communication link 2415 links one computer system 2400 with another computer system 2400. For example, the communication link 2415 may be a LAN, in which case the communication interface 2414 may be a LAN card, or the communication link 2415 may be a PSTN, in which case the communication interface 2414 may be an integrated services digital network (ISDN) card or a modem, or the communication link 2415 may be the Internet, in which case the communication interface 2414 may be a dial-up, cable or wireless modem.

A computer system 2400 may transmit and receive messages, data, and instructions, including program, i.e., application, code, through its respective communication link 2415 and communication interface 2414. Received program code may be executed by the respective processor(s) 2407 as it is received, and/or stored in the storage device 2410, or other associated non-volatile media, for later execution.

In an embodiment, the computer system 2400 operates in conjunction with a data storage system 2431, e.g., a data storage system 2431 that contains a database 2432 that is readily accessible by the computer system 2400. The computer system 2400 communicates with the data storage system 2431 through a data interface 2433. A data interface 2433, which is coupled to the bus 2406, transmits and receives electrical, electromagnetic or optical signals, that include data streams representing various types of signal information, e.g., instructions, messages and data. In embodiments, the functions of the data interface 2433 may be performed by the communication interface 2414.

Computer system 2400 includes a bus 2406 or other communication mechanism for communicating instructions, messages and data, collectively, information, and one or more processors 2407 coupled with the bus 2406 for processing information. Computer system 2400 also includes a main memory 2408, such as a random access memory (RAM) or other dynamic storage device, coupled to the bus 2406 for storing dynamic data and instructions to be executed by the processor(s) 2407. The main memory 2408 also may be used for storing temporary data, i.e., variables, or other intermediate information during execution of instructions by the processor(s) 2407.

The computer system 2400 may further include a read only memory (ROM) 2409 or other static storage device coupled to the bus 2406 for storing static data and instructions for the processor(s) 2407. A storage device 2410, such as a magnetic disk or optical disk, may also be provided and coupled to the bus 2406 for storing data and instructions for the processor(s) 2407.

A computer system 2400 may be coupled via the bus 2406 to a display device 2411, such as, but not limited to, a cathode ray tube (CRT), for displaying information to a user. An input device 2412, e.g., alphanumeric and other keys, is coupled to the bus 2406 for communicating information and command selections to the processor(s) 2407.

According to one embodiment, an individual computer system 2400 performs specific operations by their respective processor(s) 2407 executing one or more sequences of one or more instructions contained in the main memory 2408. Such instructions may be read into the main memory 2408 from another computer-usable medium, such as the ROM 2409 or the storage device 2410. Execution of the sequences of instructions contained in the main memory 2408 causes the processor(s) 2407 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 2407. Such a medium may take many forms, including, but not limited to, non-volatile, volatile and transmission media. Non-volatile media, i.e., media that can retain information in the absence of power, includes the ROM 2409, CD ROM, magnetic tape, and magnetic discs. Volatile media, i.e., media that cannot retain information in the absence of power, includes the main memory 2408. Transmission media includes coaxial cables, copper wire and fiber optics, including the wires that comprise the bus 2406. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

### Communications Interface

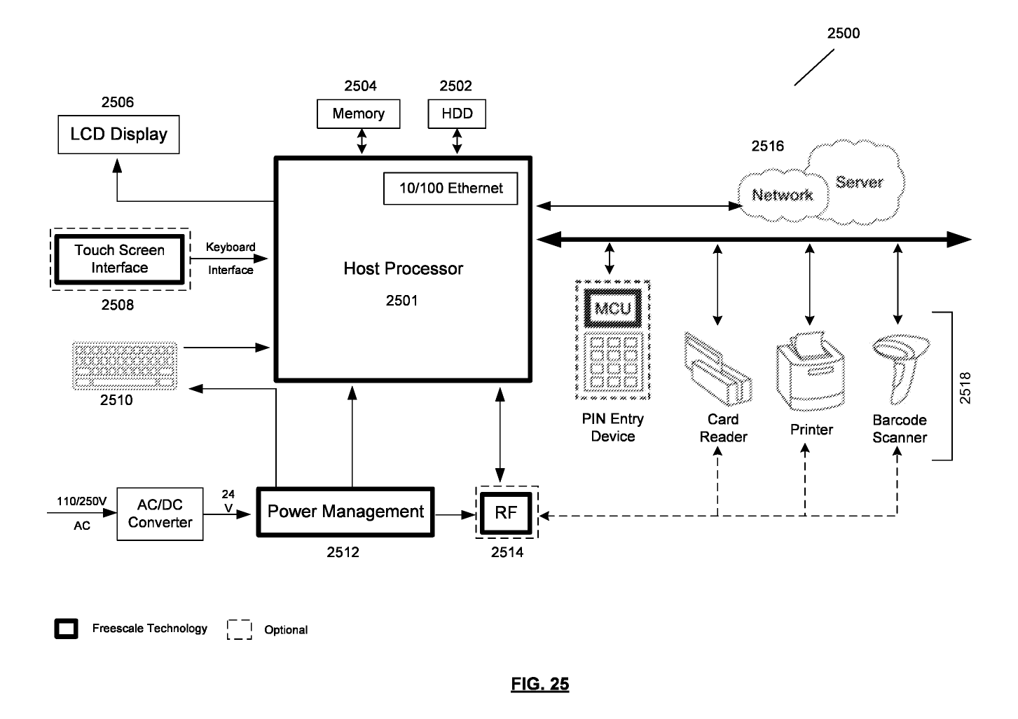

One embodiment of a communications interface 2500 is depicted in FIG. 25. The aforementioned embodiments can be carried out by a host processor 2501 that can be adapted to communicate with: a hard disk drive 2502; memory 2504; display 2506; touch screen interface 2508; keyboard or other input device 2510; power management system 2512; antenna 2514; network 2516; external devices 2518; and/or any other known or convenient device or apparatus. The interface depicted in FIG. 25 is merely one embodiment. In other embodiments, a communications interface 2500 can comprise additional and/or different components, or fewer components.

### Software Implementation

In some embodiments, implementation of the aforementioned processes and systems across platforms can be defined by the standards set forth by the Association for Cooperative Operations Research and Development (ACORD): ACORD Web Services Profile V1.1.1; ACORD XML Naming and Design Rules Candidate Recommendation V1.0.1; Document Repository Interface (DRI) Reference Guide V1.3.1; ACORD Messaging Service—SOAP V1.5.1; and/or ACORD Security Profiles V1.1.0 (all of which can be found at http://www.acord.org/standards/downloads/Pages/CDPublicl.aspx).

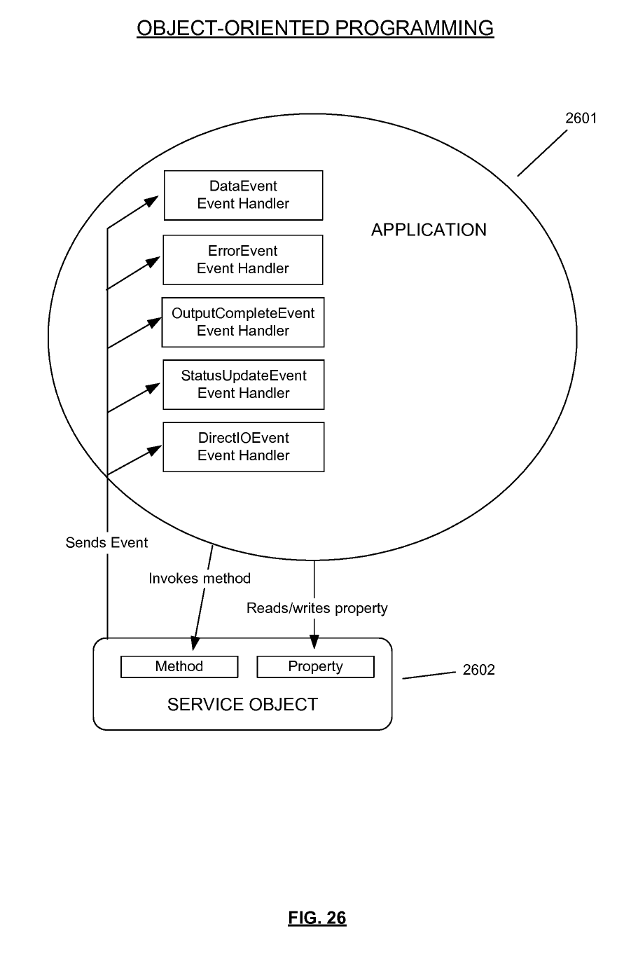

Moreover, referring to FIG. 26, in some embodiments object-oriented programming can be implemented. A main application 2601 can have at least one service object 2602 adapted to manipulate, read, and/or process data. Object-oriented programming can be utilized for data standardization purposes with the embodiments described thus far.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A method for processing electronic information for a cloud-based risk placement platform, comprising:
initiating a private cloud computing session;
initiating communication between at least one party and said private cloud computing session;
receiving at least one request by said at least one party;
acquiring predetermined information to perform said at least one request;
processing said at least one request by said at least one party; and
transmitting the results to said at least one party.

2. The method of claim 1, wherein said at least one party is chosen from the group consisting of:
cedant, reinsurer, and broker.

3. A network device with one or more processors connected to a cloud computing network with a plurality of instructions in a computer readable medium executing the steps of the method of claim 1.

4. The method of claim 1, further comprising at least one additional private cloud computing session, wherein at least two of said private cloud computing sessions are adapted to communicate with each other.

5. In a computer system having a graphical user interface including a display and a selection device, a method of providing and selecting from a menu of the display, the method comprising:
retrieving a set of menu entries for the menu, each of the menu entries representing a private cloud session option;
displaying the set of menu entries on the display;
receiving a menu entry selection signal indicative of the selection device pointing at a selected menu entry from the set of menu entries; and
in response to the signal, performing a search of a database for a match to the private cloud session option represented by the selected menu entry.

6. A computer system comprising a computer program executing on the system, wherein the program:
maintains a database of customer information;
maintains a database of historical data; and
utilizes one or more of said databases to perform one or more processes chosen from the group consisting of: risk optimization, entity rating, trading, billing, payment, commutation, claim recovery, statutory filing, and simulated data processing.

7. A virtual trading exchange method, comprising:
acquiring information from at least one cedant and at least one reinsurer;
transferring said information to at least one financial institution via at least one exchange feed and at least one order routing module; and
enabling direct communication between said at least one cedant, said at least one reinsurer, and said at least one financial institution.

8. The method of claim 7, further comprising obtaining funding from an entity chosen from the group consisting of: asset manager and hedge fund.
